(19) United States
(12) Patent Application Publication
(10) Pub. No.: US 2019/0114291 A1
(43) Pub. Date: Apr. 18, 2019

(54) Theory and Method of Unified Internet Integration(UII)

(71) Applicants: Qiang Wang, San Jose, CA (US); Jin Wang, Lang Fang (CN); Yong Wang, Suzhou (CN)

(72) Inventors: Qiang Wang, San Jose, CA (US); Jin Wang, Lang Fang (CN); Yong Wang, Suzhou (CN)

(73) Assignees: Qiang Wang, San Jose, CA (US); Xinwei Wang, San Jose, CA (US); Jin Wang, San Jose, CA (US); Yong Wang, San Jose, CA (US)

(21) Appl. No.: 16/200,516

(22) Filed: Nov. 26, 2018

Related U.S. Application Data
(63) Continuation of application No. 15/664,152, filed on Jul. 31, 2017.

(51) Int. Cl. G06F 16/22; G06F 17/24

(52) U.S. Cl. CPC G06F 16/2282; G06Q 10/10; G06F 17/245

(57) ABSTRACT

The present invention discloses the Theory and Method of Unified Internet Integration (UII) which is characterized in followings: the foundation theory of internet map/platform iconology, a series of conceptual definitions, specifications, standards and methods including a complete theoretical system and methodology invented to integrate all the Internet and other local area networks such as GIS, IoT, Block Chain etc into a whole. Especially, the present invention proposed a new concept of Positioning Oriented Architecture (POA) first time in the world and in computer science, and proposed a data structure of POA to organize all different types of icon positioning resources with other IP Address resources and service resources in a uniformed data format to form an icon positioning object to be transferred and used in all network platforms. This is impossible by all current traditional internet and network's theories and technologies.

### FIELD OF INVENTION

The present invention relates to the field of internet, more particularly the invention relates to the Theory and Method of Unified Internet Integration (UII).

### BACKGROUND OF INVENTION

Since the invention of computers and the Internet in the last century, the computers and especially the Internet have penetrated into almost all aspects of human society and are profoundly changing and transforming the life styles of all mankind as ever before, it reconstructs the new civilization and future of mankind. This is unmatched by all the technologies and inventions of the past.

With the rapid development of computer software and the Internet, various software architecture designs for computer software and the Internet are continuously being invented, improved and updated to meet the dramatic requirements of explosive growth of human being for the Internet. We can see the track of the development from the earliest message-oriented, object-oriented, service oriented architecture (SOA) and the Resources Oriented Architecture based on the invention of the Representational State Transfer (REST) architectural style in more than 18 years ago by the famous computer scientist Dr. Roy T. Fielding in his doctoral thesis, see [1]. Today, the development of Resource Oriented Architecture (ROA, see [5]) is becoming the mainstream of architectural design style in the current software development for Internet and enterprises throughout the world.

With the continuous advancement of information science, it is realized that the message-oriented architecture solves major portion of the most basic problems of information communication between different applications. The object-oriented architecture is obviously a big step, and the service-oriented architecture is a leap in the internet. Finally, the Resource Oriented Architecture (ROA) has the intention to try to integrate the Internet of Things (IoT) into the Internet. Looks like that the Resource Oriented Architecture (ROA) is the most promising approach because it has broadest coverage so far and the HTTP REST API has been a huge success in the Internet field. In 2010, approximately 74% of the web Applications were using HTTP REST APIs [2].

The present invention finds out that fatal genetic defects in all of these traditional theoretical architecture designs and methodologies above mentioned in the computer science and the Internet are the root reasons to cause the internet integration to be failure once these traditional architectural designs and methodologies were applied to address all the issues of the Internet integration with other local networks, because some extremely important features of the resources of:

(1) the further abstraction of all these resources,

(2) the cardinalities of these resources,

(3) the maximum upper limits of these cardinalities (MULC) and

(4) the logical relations between these resources

were totally ignored in above mentioned traditional architectural designs and methodologies. There is no basic concepts of the further abstraction of all these resources, no concept of quantifying the scope and boundaries of these basic elements of the resources of the Internet and information sciences, no concept of determining their logic relations between all these resources.

To date, no systematic description has been found on the fundamental issues of information science and the basic theory of the Internet, which defines clearly that the scope and boundaries or cardinalities of all these basic elements and resources of the Internet and information sciences. Due to these major fatal genetic defects, there is no way for the traditional architecture designs to integrate the Internet of Things (IoT) or other area networks into the Internet as a whole by using Resource Oriented Architecture (ROA) or other traditional architecture designs as they have encountered insurmountable obstacles. It's very difficult to dynamically determine the accurate GPS (or Beidou) coordinate position of any IP resource by using the simplest and most convenient method available so far. Because all traditional architecture designs do not take any consideration for the necessity and extreme importance of GPS (or Beidou) positioning resources. There is no consideration of any requirements for positioning resources in all the traditional architecture designs. Therefore, in all positioning systems such as GPS (Beidou etc) in the internet of Today, the coordinate positioning resources and internet architecture design are completely independent, separated and irrelevant. If you open any API standards in traditional Internet architecture designs, you can't see any important position of the GPS (or Beidou) icon positioning. These major negligence and deadly genetic defects in all traditional internet architectural designs have led to the chaos and messed-up status in which the Internet looks like a secular feudal separation.

Based on the abstraction of interactive communication of different platforms by the famous computer scientist Roy T. Fielding, we make a further step of abstraction at both the macro scope level (Internet and local area network) and micro scope level (icon positioning resource) to form different types of sets and then apply Cantor's infinite theory, logical reasoning and other basic tools for further classification and analysis, we discover some new phenomena and laws not being discovered before.

The cores of the theory and method of the Unified Internet Integration (UII) in the present invention are to explore the intersection of the frontiers of several research fields in computer science, philosophy, theory of set and Logic etc.

The present invention is based on the abstraction from the Resources to the Sets and resulted from at least four fields: philosophy, computer science, mathematics and logic. It is a combination of high-level integration and abstraction of these different disciplines. It is independently discovered these specific laws, it creates a series of conceptual definitions, & independently constructs a complete theory system and methodology to remove all these serious obstacles, genetic defects and huge bottlenecks above mentioned for the further development of the Internet and Computer Science.

The extreme importance of abstraction of internet resources to the sets and the concept definitions of quantifying the scope and boundaries of all these different types of resources and the sets in the Internet will lead to the next progress to clarify the basic logical relations between the various types of resources and the sets, between the internet and all types of local area networks, it will be identified which is the mainstream source and which is the tributary; which is the upstream and which is the downstream; which is the whole and which is the part. Then with this clear logical relation setup, we can build up the whole theory and method of Unified Internet Integration (UII). All these seemingly separated, unrelated phenomena on the surface in each discipline are actually interrelated and closely related with each other in multi-sided, more abstract, higher level scope and higher-dimensions. These laws are completely invisible in low-dimensional, single-sided, single-disciplinary levels.

Due to the long time major negligence of these basic concepts, all these traditional architecture designs including the REST framework structure invented by Roy T. Fielding's directly ignore the positioning resources of GPS (Beidou), so they ignore the extremely important set of basic resources of the Internet in micro level: The Set of Positioning Resources. The consequence of the negligence is that computer science and especially the whole Internet cannot integrate the Internet with all other networks in a way of the simplest, most convenient and most efficient theory and method.

The present invention is the world's first theory and method of Unified Internet Integration (UII) of removing all fatal genetic defects above mentioned.

The theory and method of Unified Internet integration (UII) of the present invention is to propose a new theory and approach that is totally different from all traditional approaches, which will address all foundational and critical issues in the internet that no one has ever questioned, queried, explored and solved before in the world. All these issues involve the fundamentals of the Internet, all other local area networks and computer science. The solution to these issues will shake the entire building of the Internet.

### BRIEF SUMMARY OF INVENTION

The present invention discloses a completely innovative theory, method and technical solution to address the critical issues to integrate the Internet with all other local area networks such as GIS and Internet of Things (IoT) etc together to form a unified network as a whole by the theory & method of the Unified Internet Integration (UII). According to our previous application Ser. No. 16/040,917 filing date of Jul. 20, 2018 with title of “The Foundation Theory and Method of Internet Map/Platform Iconology/Markerology”, see [4], we use this Iconology's theory and method with Philosophy, Mathematics and Logic to establish the world's first theory and method of Unified Internet Integration (UII).

### BRIEF DESCRIPTION OF DRAWINGS

Some of the embodiments of the present invention are illustrated as examples and are not limited by the figures of accompanying drawings, in which like references may indicate similar elements and in which:

FIG. 1: Three Traditional Something-Oriented Architectures:

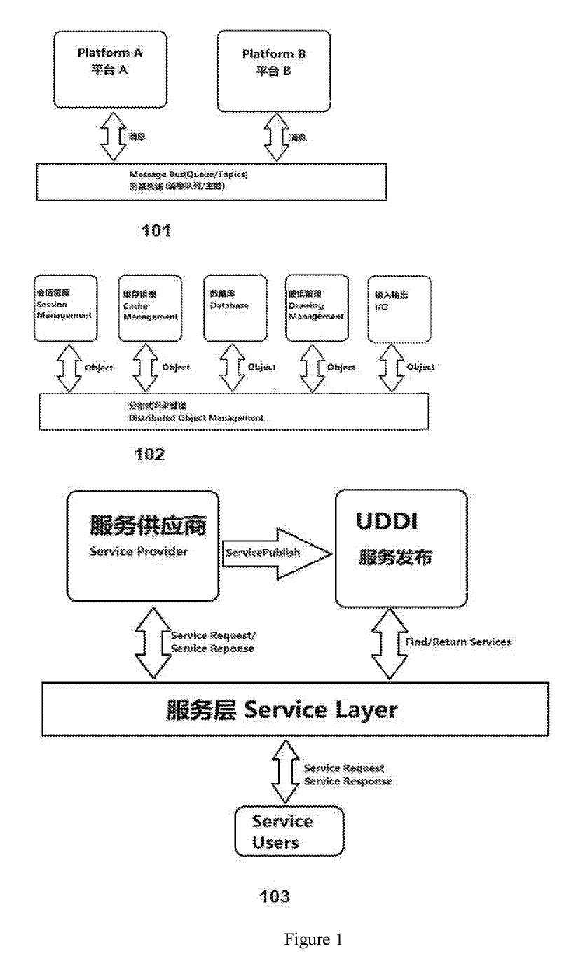

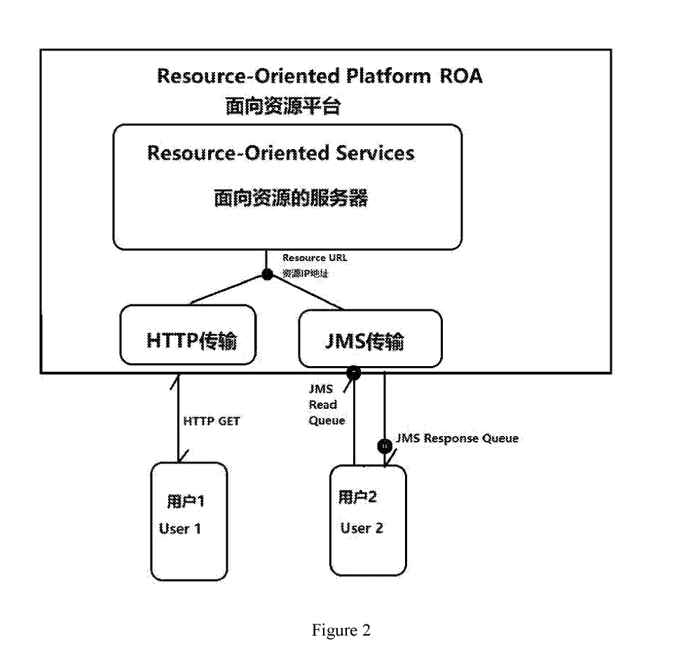

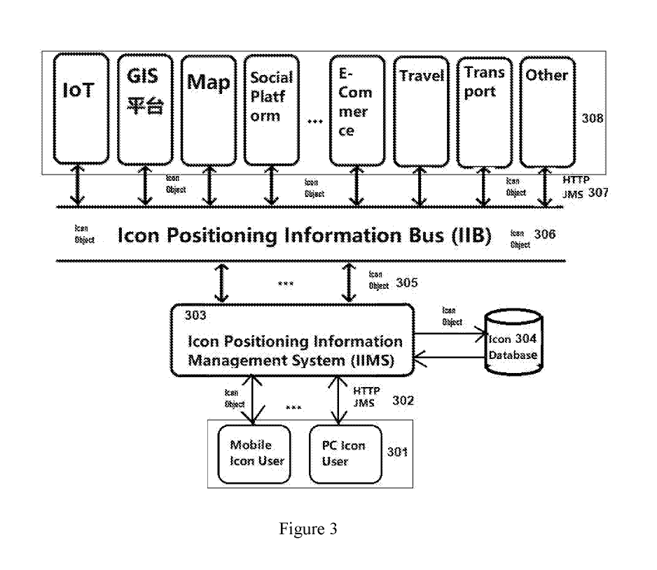

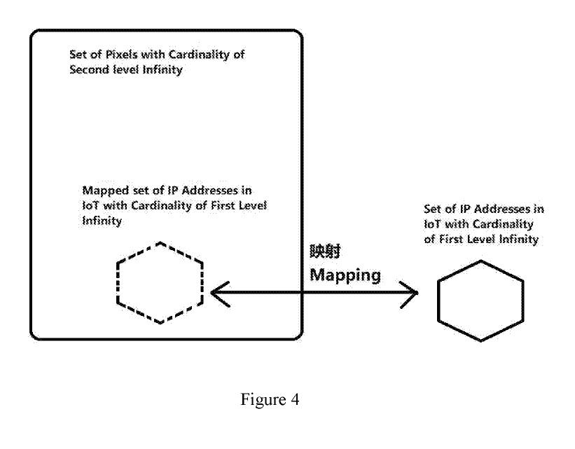

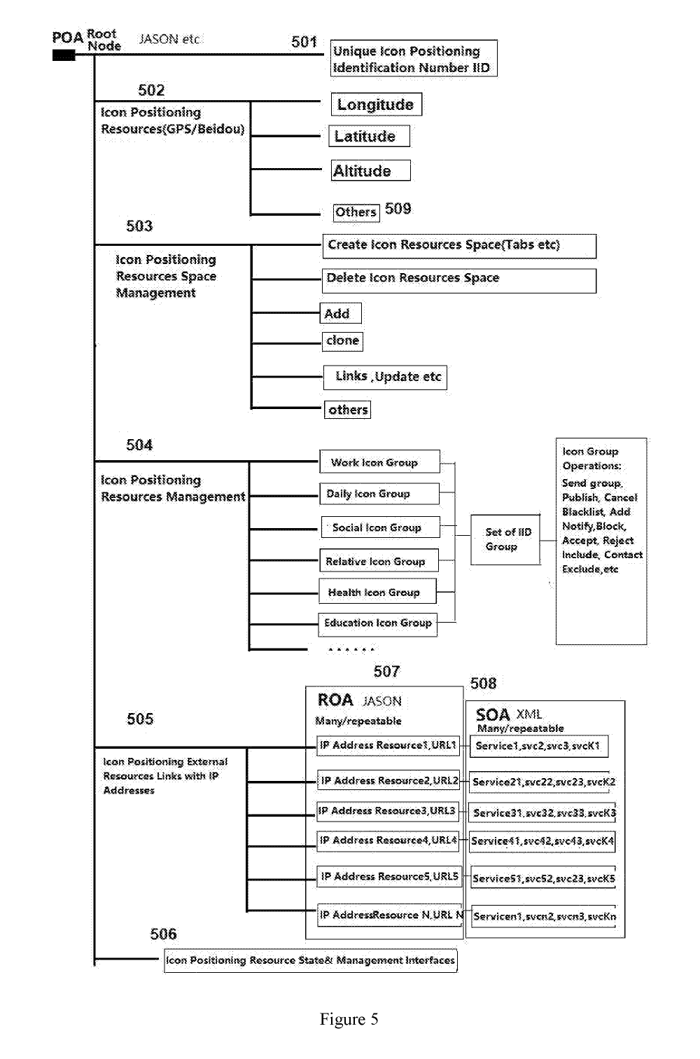

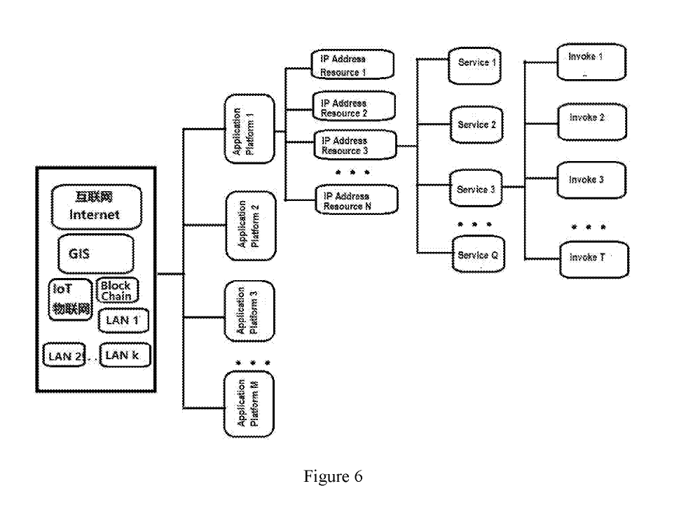

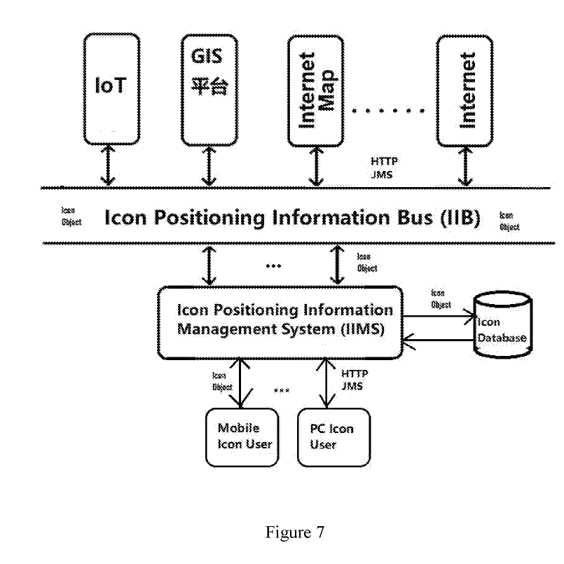

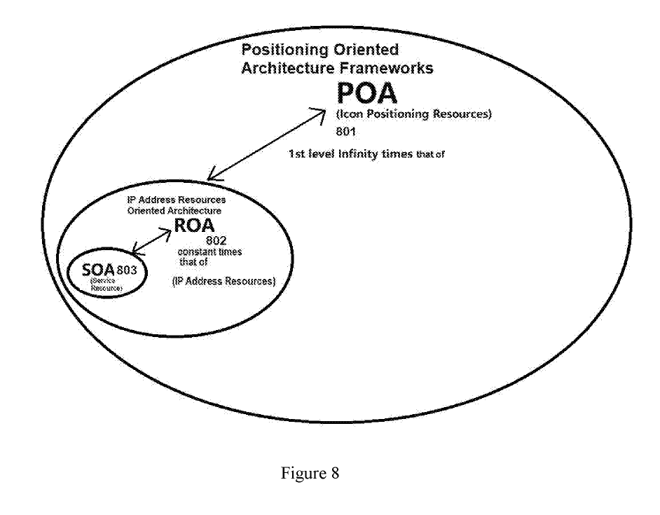

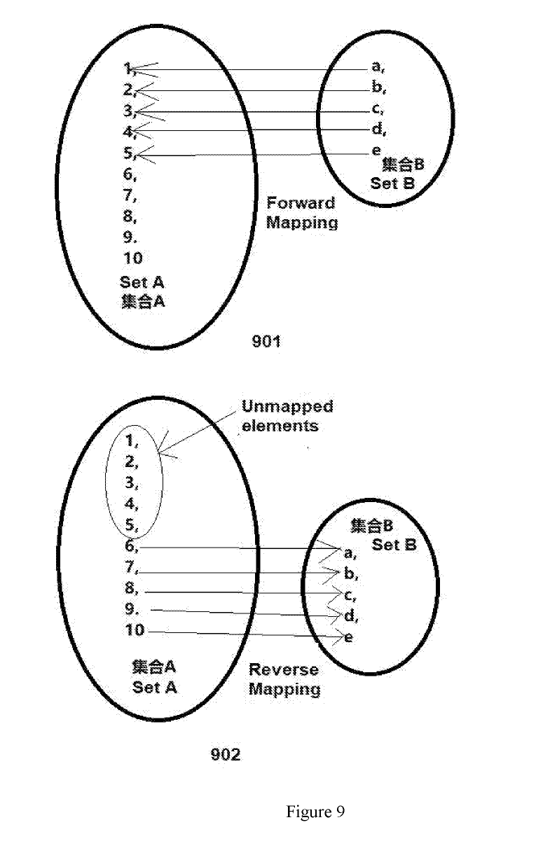

101 is the traditional message-oriented architecture design, where the information bus is the message bus; the traditional communication method is to transmit the message by the queues or the topics between the platforms through the information bus.

102 is the traditional Object-Oriented Architecture design, where the information bus is a distributed object management bus; the communication method of traditional object-oriented architecture design is to transfer objects between different platforms through the information bus;

103 shows the traditional Service-Oriented Architecture (SOA) design, where the information bus is the service management (bus) layer; the communication method of traditional service-oriented architecture design is to transfer services objects between different platforms through the service layer.

FIG. 2 shows the traditional Resource-Oriented Architecture (ROA) design for IP address resources; At present, it is the most popular architecture for IP address resources, Here the IP address resource objects are mainly transmitted through HTTP & Java message services (JMS).

FIG. 3 shows that Icon Positioning-Oriented Architecture (POA) design and the basic components of POA.

301 is PC or mobile terminal users; 302 shows the protocols used between the users and IIMS servers; 303 shows the icon information management system (IIMS) service; 304 shows the database to persist all icon positioning object information; 305 shows the Icon Positioning Objects exchanged between IIMS and all other networks through Icon Information Bus (IIB); 306 shows the Icon Information Bus (IIB) to transfer all icon objects; 307 shows the protocols used between the Icon Information Bus (IIB) and all other networks; 308 shows all other networks such as the Internet, GIS, IoT, Block Chain etc.

Here, all icon positioning resource objects transferred in the Icon Information Bus (IIB) contain all the information used and exchanged by all the different types of network in order to communicate with each others. IID is a unique icon identification number to distinguish from each others. The Icon Information Management System (IIMS) will receive, process, reply and store all the icon positioning resource objects in the backend databases, IIMS has a lot of applications to trigger the processes once receive the request from the client or from other applications, then it will process the icon positioning resource objects received, maintain and persist them. So IIB and IISM are not only the main aorta and information bus to integrate the icon positioning resources of all different types of network platforms, but also the core framework of the Unified Internet Integration (UII).

FIG. 4 shows the Mapping between different types of LANs and Internet

Through the mapping method of Cantor's theory of set, each set of local area network can be mapped to the set of Internet, and the logical relation between these mapped sets and the set of Internet icon resources is established according to the maximum upper limit of the cardinality (MULC) of resources of each local area network we defined before. IP address resource is in integer domain and it has a MULC of first-level infinity, the logical relation between the Internet map and all other different types of networks is that the set of Icon Positioning Resources is whole set; all other sets of different types of resources in different types of networks are subsets of the whole set; the difference of MULCs between the whole set and all the subsets is first-level infinity;

FIG. 5 shows data structure of Positioning-Oriented Architecture design(POA) used in the theory and method of Unified Internet Integration (UII); FIG. 5 also details the data structure and framework of the icon positioning objects in the POA.

The data structure framework of POA for icon positioning resources is original to the present invention; and it is described in detail below,

(1) Icon positioning resource identification number IID

(2) Icon positioning resource (GPS/Beidou positioning)

(3) Icon positioning resource space management (manage resource spaces of each icon)

(4) Icon positioning resource management (manage groups of icons)

(5) Icon positioning external resource link management

(6) Icon positioning resource current status and its status management interfaces;

The data structure of the POA in the present invention determines the positions of the all other traditional approaches such as resource-oriented architecture (ROA) and the service-oriented architecture (SOA) in the whole structure of POA, this newly invented data structure is for the next new generation of internet/network architecture design, it also shows the possible data schema currently used such as JASON, XML etc, as shown in FIG. 7.

Here, please see 501 for (1); see 502 for (2); see 503 for (3); see 504 for (4); see 505 (5); see 506 for (6), 507 and 508 shows the relation of ROA and SOA, 509 means that for the element of Icon Positioning Resource in the POA data structure, there are some more attributes or properties available if required.

FIG. 6 shows the relations among Internet and different types of Local Area networks, application platforms, IP address resources, services and methods. It is shown that the present invention creates an architectural framework at the root level of the Internet and all others local area networks.

FIG. 7 shows the application examples of the Unified Internet integration (UII) and POA in a complicated environment composed of Internet and all others different types of local area networks.

FIG. 8 shows that some basic relations among Service Oriented Architecture (SOA), IP address Resource-Oriented Architecture (ROA) and icon Positioning-Oriented Architecture (POA) frameworks, It indicates that all sets of different types of resources (Service Resource, IP Address Resource and Icon Positioning Resource) have different max upper limits of cardinalities (MULC).

801 is the set of icon positioning resource, and it has the maximum upper limit of the cardinality (MULC) of the second level infinity;

802 is the set of IP address resource; and it has the maximum upper limit of the cardinality (MULC) of the first level infinity;

803 is the set of service resource; it has the maximum upper limit of the cardinality (MULC) of the first level infinity also, but the number in IP Address resources is much bigger than the one in service resource; so the set of service resource is subset of the set of IP address resource.

FIG. 9 shows both Forward Mapping and Reverse Mapping, here,

901 is the Forward Mapping refers to the mapping from a set B of elements with a smaller cardinality to a set A of elements with a bigger cardinality. Obviously, In a forward mapping, for a smaller set B of elements, none of the mapping elements are missing.

902 is the Reverse Mapping refers to the mapping from a larger set A of elements to a smaller set B of elements. Obviously, in reverse mapping, the set A has more than one elements that cannot be mapped to set B, that is to say that some elements in the set A can't find any unique mapping element in the set B.

### DETAILED DESCRIPTION OF THE INVENTION

The Terminology used herein is for the purpose of describing particular embodiment only and is not intended to be limiting of the invention. as used herein, the term “and/or” includes any and all combinations of one or more of the associated listed items. As used herein, the singular forms “a”, “an”, and “the” are intended to include the plural forms as well as the singular forms, unless the context clearly indicates otherwise, It will be further understood that the terms “composed” and/or “comprising,” when used in this specification, specify the presence of stated features, steps, operations, elements and/or components, but do not preclude the presence or addition of one or more other features, steps, operations, elements, components, and/or groups thereof.

Unless otherwise defined, all terms (including technical and scientific terms) used herein have the same meanings as commonly understood by one having ordinary skill in the art to which this invention belongs. It will be further understood that terms, such as those defined in commonly used in dictionaries, should be interpreted as having a meaning that is consistent with their meaning in the context of the relevant art and the present disclosure and will not be interpreted in an idealized or overly formal sense unless expressly so defined herein.

Here we define that all icons are same as the markers in internet maps in the present invention, ie a icon is same as a marker and that Iconology is same as Markerology, and that internet is same as networks in the present invention, also we define valid icon/markers are same as effective icon/markers. Here valid/effective icon/markers means that these icon/markers are associated with human beings daily life or business commercial or production or social activities such as shopping, hospital, education, tour, transportation, agriculture, manufacturing etc, we also define that the internet map also is an abbreviation of internet map/platform, because the icons/markers we use here can be not only used in the internet maps such as Google Map, Baidu map etc but also used in all other platforms and their applications such as all types of GIS and all types of IoTs, BlockChain and local area networks so the term of platform or “Platform” means all different types of GIS platforms or LoT platforms or any platforms that will use the concepts of icons/markers or the similar defined here. In the present invention, the Positioning Oriented (or icon-oriented) Architecture (POA) design is the world's first new original architecture design. The key in the POA is that in the Positioning Oriented Architecture (POA) design, the present invention uniquely develops the world's first systematic theory and method named as UII with a complete collection of original concepts, rules and operations. The internet icon positioning resources with unlimited resource space and accurate GPS (or Beidou) positioning coordinates, which have the max upper limit of cardinality (MULC) of 2nd level infinity as per Cantor's the Theory of Set, with a POA data structure for the communication between all Internet and local area networks will form the foundation of UII,

In the present invention, firstly internet icon positioning resources objects will occupy the place of top priority in the Positioning-Oriented Architecture (POA) design, which shows that Positioning resources will be extreme important and will completely occupy all first-class positions previous occupied by other traditional resources in all traditional architecture designs, such as Message-Oriented, Objects-Oriented, Services-Oriented Architecture (SOA), and IP address resources-Oriented (ROA) etc, here in the present invention, it is not to remove all messages, objects, services, and IP address resources etc, but to use these resources as sub-elements of POA's to encapsulate all existing different types of traditional resource of the internet and area networks to complete much greater and difficult tasks.

Secondly, The uniqueness of the icon identification number (IID) created in [4] and in FIG. 5 will guarantee the accuracy of the integration of the Internet.

Thirdly, according to Cantor's the Theory of Set and Infinity, the maximum upper limit of the cardinality (MULC) of the pixels/icons with the representation of the icon number IID is the second level infinity, and the maximum upper limits of cardinality (MULC) of all other elements/resources such as messages, objects, services and IP address resources are only the first Level infinity, and the second level infinity is the first level infinity multiple of the first level infinity, so the maximum upper limit of the cardinality (MULC) of the icon number is much much greater than the maximum upper limit of the cardinality (MULC) of all other resources in all traditional architecture designs. In other words, all other resources can be ignored directly for the icon positioning resource. So in all IPV6, IPV9 etc, IP address is a finite number, far far less than any large number in the first level infinity series, and much much far far less than any large number in the icon positioning resources set with max upper limit of cardinality (MULC) of second level infinity.

The present invention defines a series of following concept definitions to setup the cores and backbone of the Theory and Method of Unified Internet Integration (UII).

### Concept Definition 1: Internet Resources

The Internet resources are Internet software, links, web addresses (including all LANs), web pages and their elements (various buttons, drop-down menus, etc.) and documents and transport protocols that provide all useful information. Therefore, Internet resources also include all messages, objects, events, methods, services, IP addresses, and internet positioning information of internet map pixels and icons. The distinguished difference between traditional architecture design framework and POA is that the present invention primarily focuses on the resources with the max upper limit of cardinality (MULC) of the 2^{nd} level infinity in the Internet: icon positioning resources.

### Concept Definition 2: Types of Resources for the Internet and all LANs

In the theory of Unified Internet Integration (UII), the types of resources of the Internet and all local area networks are completely different. The values of max upper limit of cardinality (MULC) for these different types of resources are also different. These different kinds of resources of Internet and of local area networks include icon positioning resources, IP Address resources, service resources, object resources, method resources, message resources, event resources, etc., as listed below:

(1) Type 1: Icon positioning resources are mainly used in POA for internet maps and GIS, IoT as well as block-chains, etc.

(2) Type 2: IP address resources are used for Resources-Oriented architecture (ROA) design for IP address resources) and REST,

(3) Type 3: Service resources are used for Service-Oriented Architecture (SOA) Design,

(4) Type 4: Object resources (object-oriented architectural design of object resources),

(5) Type 5: Method resources (architecture design for method resources),

(6) Type 6: Event resources (Event-oriented architecture design for event resources) such as CEP (Complex Event Processing),

(7) Type 7: Message resources (Message-oriented architecture design for message resources), etc

### Concept Definition 3: Internet Resource Set

The present invention abstracts all Internet resource collections such as internet map icon positioning resources, IP address resources and service resources and object resources of the Internet, GIS positioning resources, IP address resources of the Internet of Things (IoT), and all resources of all local area networks into the sets of different types of resources. Then all sets of these different types of resources can be processed and treated by G. Cantor's set theory methods and rules.

### Concept Definition 4: The Maximum Upper Limits of Cardinality (MULC) for the Sets of all Internet and all LAN Resource

According to Cantor's infinity theory, we find that the MULC of the various resource sets defined in Concept 2 may be different.

The maximum upper limit of Cardinality (abbreviated as MULC) for each type of set of resource (collection) is as follows:

(1) The MULC of the icon positioning resource set is the second level infinity.

(2) The MULC of the IP address resource set is the first level infinity.

(3) The MULC of the service resource set is the first level infinity,

(4) The MULC of the object resource set is the first level infinity,

(5) The MULC of the method resource set is the first level infinity,

(6) The MULC of the event resource set is the first level infinity,

(7) The MULC of message resources is the first level infinity;

Here, except that the MULC of the icon positioning resource set is the second level infinity, all the other resource sets have the same MULC of the first level infinity, that is, the set of all integers.

### Concept Definition 5: The Value of the MULC of Each Resource Set Determines the Positions in the Logical Relation of the Different Types Resources in the Theory of Unified Internet Integration (UII)

According to the mapping method in Cantor's infinity theory, all first-level infinity resource sets can become subsets of Second-level infinity resource sets by mapping to the set of second-level infinity resource, the set of POA's resource and these mapped subsets will form a relation of inclusion, of affiliations, of primary and secondary, of the global and the local and of the active and the passive. Therefore, the set with smaller value of the MULC will be dominated and controlled by the set with larger value of the MULC, ie, the set with cardinality of second level infinity will dominate and control the mapped set with cardinality of first level infinity. So the icon positioning resource set can include and integrate all other resource sets that have the MULC of the first level infinity:

(1) The icon positioning resource set can impact, control and integrate the mapped sets of IP address resource, service resource, activity resource, method resource, event resource, message resource and other resource;

(2) The mapped set of IP address resource can only be impacted, dominated and integrated by the icon positioning resource set;

(3) The mapped set of service resource can only be dominated and integrated by the set of icon positioning resource and IP address resource set, and the rest is similar.

(4) The set of icon positioning resource with the cardinality of second level infinity cannot be impacted, controlled and integrated by the mapped sets of IP address resource, service resource, activity resource, method resource, event resource, message resource and other resource that all have cardinality of first level infinity; That is, by using the mapping method in the theory of Set, the MULC of these resources determines their logical position of relation in the theory of Unified Internet Integration (UII). This logical position of relation is the relation of primary and secondary, and this logic position in the logical relations in the UII can be used to determine whether they can integrate or impact other resources or can be integrated by other resources.

### Concept Definition 6: The Positions of the Different Types of Resource Sets with the Same MULC in the Logical Relation in the Theory and Method of Unified Internet Integration (UII)

This mainly refers to the following types of different types of Internet resource collections/sets but all have the same MULC:

Here, based on the experience of using the Internet, the valid finite number of set of resource (such as the number of users, the number of IP addresses, the number of services etc) can be determined by simple search.

The set of IP addresses has biggest value (IPV9 can be 2¹³²), the set of users of internet is next (max number can be 7 billion of global population), the set of services next and so on;

The same thing for GIS positioning resources and the internet map pixels or icon positioning resource, they all have same MULC of sets and they are all the second level infinity, But the Internet is the mainstream platform for human beings in the information society in our daily life, the number of Internet users and applications is much much larger than ones in GIS in constant level, so from this point of view, we regard the GIS resource set as a subset of pixels or icon positioning resources that directly map the set GIS positioning resource into Internet maps as a local area networks of the internet. Ie, the set of GIS positioning resource becomes a subset of the set of the Internet map icon positioning resource after mapping. We will see this classification is extremely important in the present invention of UII.

### Concept Definition 7: Determination of the MULC of all Sets of Different Types of Resource in the Internet and all LANs

the MULC of all sets of different types of resource in the Internet and all LANs can be obtained by using Cantor's infinity theory.

### Concept Definition 8: Components of Positioning Oriented Architecture (POA) Design

The Positioning-Oriented Architecture (POA) design of icon resources consists of at least the following eight components:

(1) Positioning resources (icons)

(2) Positioning resource Identification (unique icon identification number IID)

(3) Description of the positioning resource (icon description, including GPS/or Beidou positioning values such as Longitude, Latitude, Altitude, etc.);

(4) Resource space for each positioning resources and their operation management (icon resource space);

(5) The relation between different positioning resources (the relation between a current icon and multiple focused icons, links, communication methods, operations, group attribution, etc.);

(6) Local IP address resources (multiple) such as IoT/GIS/Block Chain associated with each positioning resource or icon;

(7) The service types associated with each IP address resource (multiple) in the local area network such as IoT, these IP address resources are also associated with each positioning resources (optional) or icons;

(8) The methods associated with the each service (multiple optional); see FIG. 5.

### Concept Definition 9: Differences Between Positioning Resources Architecture (POA), SOA and ROA

The differences between Positioning Resources Architecture (POA) and others such as ROA and SOA are totally distinguished. The differences between the MULC of POAs' resources and the the MULCs of ROA and SOA resources are the first level infinity as per Cantor's theory of Set, ie it is not a difference of constant value but infinity; and all other resource sets with the same MULC such as IP address resources, services resources etc have a difference of constant value but same the MULC.

### Concept Definition 10: The Consistency of Naming Convention of Unified Internet Integration (UII) Architecture Design

In the present invention, all the following descriptions are equivalent, that is, all the naming convention is consistent:

(1) POA=Positioning Oriented Architecture

(2) IOA=Icon Oriented Architecture

(3) MOA=Marker Oriented Architecture

Here, POA, IOA and MOA are all the same, normally we use first one POA; Icons and markers are ones in internet maps etc; the framework of data structure of POA for icon positioning resources in FIG. 5 is originated in the present invention;

### Concept Definition 11: Forward Mapping and Reverse Mapping

For set A and set B, the number of elements in set A is greater than the number of elements in set B. Unlike traditional mapping definitions, the forward and reverse mappings are defined here: An element in set A can map an element in set B. And can map the only one element in B, this mapping is called Forward Mapping;

Using Cantor's mapping method, forward mapping refers to mapping from a set B with fewer elements to a set A with more elements. Obviously, for a set with fewer elements, there is no missing element of the mapped element of Set B; That is, in a set with fewer elements, all elements can find a unique matching object or item in the set with more elements. See FIG. 9.

The reverse mapping refers to mapping from a set A with more elements to a set B with fewer elements. Obviously, the reverse mapping has more than one mapping element missing, that is, a set A with more elements will have some elements to map to nothing. Some elements in set A can't find a unique matching items in a set B with fewer elements. See 902 in FIG. 9.

Only the forward mapping is discussed in the POA, and the reverse mapping causes the resource to be lost during mapping.

### Concept Definition 12: The Importance of Determining the Logical Relation of Different Types of Resource Sets in UII

It is extremely important to determine the relations of primary sets and secondary sets or subordinates, and ones of global and local sets between the sets different types of resource in the Internet and the Internet of Things (IoT), such as GIS, Block-chain and all area networks;

Since the Internet is a global network, all local area networks such as GIS, block chain and Internet of Things (IoT) are the subsets of the set of global network/Internet; through the mapping of Cantor's theory of set, all sets of local area networks such as GIS, block chain and Internet of Things (IoT) can be mapped into the set of Internet. All information of the basic resources of the global network/internet can be shared in the global Internet environment by both the set of internet and the subsets mapped; therefore, the attributes/properties of the positioning resources of Internet with its genetic defects will directly have dramatic impact on the further development of all these subsets mapped.

Similarly, if the attributes/properties of the positioning resources of the Internet with its genetic defects are reconstructed or updated by removing these genetic defects, these updated attributes/properties of the internet with positioning resources will directly improve and promote the further development of these local area networks. In our previous invention application of “The Foundation Theory and Method of Internet Map/Platform Iconology/Markerology”, it completely renovate the all attributes/properties of traditional Internet positioning resource (icon system) by removing all fatal genetic defects. The modified Internet positioning resource (icon system) abandoned all the fatal defects of the traditional positioning resources and added a lot of new attributes/properties to construct a new icon system that has greatly promoted the further development of all local area networks such as GIS, block chain and Internet of Things (IoT) and other local networks, see [4].

### Concept Definition 13: The Data Structure and Schema for POA/IOA/MOA

As mentioned before, POA is compatible with all of the current data structures such as XML, JASON, TEXT etc used in the Internet communication protocols, as shown in FIG. 5. That is to say, all the other resources with different data formats can be included as sub-nodes or subset under the root node of the POA data structure. For example, the IP address resource in ROA with JASON data format or XML data format or other can become one or many optional sub-nodes under the POA root node, as long as the application processes in Icon Information Management Services (IIMS) server can parse all the data received by the existing data schema. See FIG. 5. This data structure of POA is invented by the present invention and can be accepted by all different types of networks such as the Internet, GIS, IoT, block chain and other local area networks through the Icon Information Management Services (IIMS) server and the icon positioning communication information bus (IIB). It is compatible with all current in-use data structures and internet applications. Only difference is at the root node level, the root element is identified as an icon positioning resource object with many properties or attributes newly updated by removing all fatal genetic defects, and all IP Address resources and all their resources become sub-nodes or sub-elements as shown in FIG. 5.

### Concept Definition 14: Relation Between POA and Big Data

The set of resources of POA is a set of icon positioning-oriented resources with a MULC of second-level infinity. However, the current concept of big data is vague and not clearly defined, and It should mainly refer to the sum of ordinary network resources of infinity, such as service resources, message resources, IP address resources, object resources, and so on. Looks like that the positioning resources are not explicitly included in this big data so far because of long time of ignorance of positioning resources. Since the POA has clearly defined and proposed the icon positioning resource for the first time in the world, the MULC of set of existing big data is belong to the first level infinity in the POA framework, and the MULC of the icon positioning resource is the second level infinity, so the difference in the MULC of sets between POA and big data is the first-level infinity. That is to say, under the POA framework, the currently so-called popular “big data” is actually trivial and small data, it is incomparable with icon positioning-oriented resources.

### Concept Definition 15: The Relations Between Internet, Application Platforms, IP Resources, Services and Methods

At the Internet level, there are the Internet and a number of different local area networks such as GIS, block chain, Internet of Things (IoT) and numerous local area networks;

There are countless application platforms on the Internet, and each LAN has at least one application platform, ie the Internet and each of LANs have multiple application platforms;

Each application platform has at least one or multiple IP address resources.

Each IP address resource has at least one to multiple services resource.

Each service has at least one or more methods to be invoked, as shown in FIG. 6. Roy T. Fielding invented REST style design methodology and later a new architecture for IP address resources ROA is developed to solve the interactive communication between all different platforms within internet. The present invention of the Position Oriented Architecture (POA) will solve the interactive communication among all Internet, GIS, block chain, Internet of Things (IoT) and various local area networks. For this level of interactive communication, all current traditional theory and methodology such as ROA and SOA have no ability at all because they all have fatal genetic defects.

### Concept Definition 16: Encapsulation of Icon Positioning Information of POA

The Theory and Method of Unified Internet Integration (UII) uses the Positioning Oriented Architecture (POA) design to encapsulate all the details of Icon Positioning Resource Information during transmission when sending and receiving icon positioning objects in the icon information bus on the Internet. The icon identification number (IID) is a unique identifier and can be identified by all networks.

### Concept Definition 17: Delivery of Icon Positioning Resources Information of POA

The Theory and Method of Unified Internet Integration (UII) uses the Positioning Oriented Architecture (POA) design to encrypt or non-encrypt the icon positioning object when sending an icon positioning object in the icon information bus (IIB) on the Internet.

### Concept Definition 18: Reception of Icon Positioning Resource Information for POA

The Theory and Method of Unified Internet Integration (UII) uses the Positioning Oriented Architecture (POA) design to accept any decrypted or non-decrypted icon positioning object when receiving an icon positioning object in the icon information bus (IIB) on the Internet. Then it uses prepared schema like Jason/WL or others to parse the icon objects received to decompose all data encapsulated in the icon objects for further processing.

### Concept Definition 19: POA Icon Positioning Information Management Service

FIG. 3 depicts the basic concept of the Icon Positioning Information Management Service (IIMS) server that is the center of all icon information bus and all network platforms communicate with each other through it. The IIMS server stores all basic information of all icon positioning objects including icon identification number (IID), icon positioning resource management, icon resource space management, icon resource management, icon positioning external resource link management and other core contents in database; The IIMS server have a lot applications in server side to process all requests sent from customers and communicate with backend systems during the processing, after complete all processing, IIMS will encapsulate the results as a response and then send back icon object as a response to the customers, these customers include all mobile terminals, PCs, all IoT Users, all GIS users and block chain users also.

### Concept Definition 20: POA Icon Positioning Information Bus (IIB)

The theory and method of the Unified Internet Integration (UII) by using the POA will transfer the icon positioning object through the icon positioning Information bus (IIB), It fully inherits the concept of patent application see [4], It includes:

(1). The Icon information Bus (ie icon information bus IIB), it is the information bus for all the network platforms to exchange and transport icon objects with unique IID with each other. It is the main aorta to integrate the icon positioning resources of all network platforms. See FIG. 3.

### Concept Definition 21: The Communication Between all Networks in POA

The Theory and Method of Unified Internet Integration (UII) uses the POA to let all global and local networks communicate with each others. Through the icon information bus (IIB), the controllable Icon Positioning Information Management System (CPIMS) or the icon information management system IIMS, and the icon positioning objects, we can fully implement followings basic communication models such as point-to-point, request response, publish-subscribe etc

(1) between all platforms within the Internet

(2) between the Internet and local area networks (such as GIS, Internet of Things (IoT), block chain, and all national corporate enterprise LANs)

(3) among all platforms between local area network and local area network (such as GIS, IoT Internet of Things, block chain, all national community enterprise business local area network);

The prerequisites are to adopt the Foundation Theory and Method of Internet Map/Platform Iconology/Markerology, and then to adopt the theory and method of Unified Internet Integration (UII).

### Concept Definition 22: The Relations Among the MULC of the Resource Sets Between POA, ROA and SOA

For the first time in the world, the present invention discloses clearly the relations of the MULC of the resource sets between POA, ROA and SOA. The MULCs of the all other resource sets of ROA, SOA etc are the 1st-level infinity; The MULC of the resource set of POA is the 2nd-level infinity, so The MULC of the resource set of POA is first-level infinite multiple of MULC of ROA and SOA. But the MULC of the resource set of ROA is the finite constant multiple of SOA's one. The controllable icon positioning resources, IP address resources and service resources are the three most important basic backbone resources of the Internet at present, and IP address resources and service resources are the basic backbone resources of the traditional Internet. Controllable icon positioning resources are the most critical and fundamental resources of the next generation of Internet, and Controllable icon positioning resources are the largest resources of the Internet so far developed by our series of inventions. All icon positioning resources within POA are controllable. But All icon positioning resources within ROA and SOA are uncontrollable.

Because the IP address resource in IPv6 uses a 128-bit address, theoretically allowing 2¹²⁸, or approximately 3.4×10³⁸ addresses. Therefore, the max upper limit of the cardinality of the positioning resource of the ROA is a finite constant multiple of the max upper limit of the cardinality of the resource of the SOA, See [3]. See FIG. 8: the relations between the MULCs of the resource sets among POA, ROA and SOA.

### Concept Definition 23: Controllable Positioning Resources and POA

In traditional architecture design and Internet, positioning resources such as icons/markers in the internet map and GIS etc is uncontrollable, ie all these positioning resources of icons/markers cannot be controlled by the end users. Due to the lack of the foundation theory of Internet Iconology, traditional architecture designs and Internet have no ability to control all positioning resources. That is to say that the whole computer world and the Internet all over the world have no concept of controlling the positioning resources that are the biggest resources in Internet, and from the point of view in Iconology in [4], all the uncontrollable positioning resources have no value of further development in the Internet. All the positioning resources in POA are fully controllable, so all the controllable positioning resources in POA have greatest value of unlimited development in the Internet.

### Concept Definition 24: Difference Between UII and EAI

The EAI is the Enterprise Application Integration within each of the enterprises throughout the world, but the UII is the Unified Internet Integration, they belong to total different levels and scopes of integration, as per the theory of Set by G. Cantor, the all sets of resources of EAT are subsets of UII. The UII is much higher level abstraction and integration than EAI.

### Concept Definition 25: The Scope of Theory of the Unified Internet Integration (UII)

The Unified Internet Integration (UII) is to adopt the framework of the icon or Positioning-Oriented Architecture (POA) to implement the interactive communication and integration of the Internet and all other local area networks, and implement the information sharing of icon positioning resources. The foundation theory of Internet Iconology in [4] is the core and basis of the framework of the Positioning-Oriented Architecture (POA), see [4].

In order to achieve the Unified Internet Integration (UII) to be applicable throughout all Internet and local area networks, for all following integration in the Internet and local networks such as:

(1) Network level

(2) Platform level

(3) IP resource level

(4) Layered level

(5) Application level

(6) Service level

(7) Operational level

(8) Data level

the core of the present invention is focused on the root level integration at the top level of all different types of networks such as Internet, GIS, IoT, block chain and other Local Area Networks. See FIG. 3, 6 and FIG. 7.

### A Specific Embodiment

The following clearly and completely describes the technical solutions in the embodiment of the present invention. Apparently, the described embodiments are merely some but not all of the embodiment of the present invention. All other embodiment obtained by a person of ordinary skill in the art based on the embodiment of the present invention without creative efforts shall fall within the protection scope of the present invention.

Referring to FIGS. 3 and 7, an embodiment of the present invention includes: The specific steps of the theory and method of Unified Internet integration (UII) are:

Step 1: The current user TESTER sends a related request to the internet web service server or the Icon Information Management System (IIMS) cloud server created by the present invention by clicking the icon on the applications of current mobile terminal cellphone or the PC, and the request encapsulates all the information in the icon object with a format of the POA data structure specified in FIG. 5;

Step 2: The request with the icon object with unique icon Identification number IID of 1000001 is sent to the IIMS server through HTTP/HTTPS, and the IIMS server receives the icon object in a data format of the POA data structure specified in FIG. 7;

Step 3: The IIMS server will invoke a corresponding process to parse the icon object that just received from the request, and separate all different service requirements;

Step 4: The IIMS server will invoke different processes, programs and service algorithms to handle all different types of requirements based on the parsed results in Step 3 according to different service requirements;

Step 5: The IIMS server will call backend systems to retrieve all related information stored in the database by unique icon Identification number IID of 1000001 and if necessary to call other legacy systems to get data needed to process requested services or to get other related icon objects information from backend system through their unique icon Identification number IIDs;

Step 6: finally to pack all processed results (including group of related icon objects) into one icon object in a data format specified in FIG. 5, and to return the requested processing result as icon object to the user TESTER in a package, and simultaneously stores all the icon information processed into the database by the icon identification number IID of 1000001;

step 7, the user TESTER receives the icon object with icon identification number IID of 1000001, then process the all information contained in the icon object from the IIMS server, and the local programs will start decrypting, parsing, processing and obtaining the required result to display on the user interface.

Step 8: If the algorithm is not working normally, the system will process the operation result accordingly to handle any error and exceptions. If the algorithm runs normally, the system will display all the results on the user interface of the mobile terminal or PC after the all operations were completed;

### Specific Embodiment 1

As shown in FIG. 7, the current user TESTER sends a request to the Icon Information Management System (IIMS) server or the cloud server by clicking the icon with the icon identification number IID of 1000001 in the user interface at the current mobile terminal or PC. The requested icon object will have a structure in a data format specified in FIG. 5, it will contains part or all of the requirements of 502, 503, 504, 505 and 506 in FIG. 5, such as creating a resource space, require the creation of a resource space for the specified icon IID of 1000001. The request uses the POA data structure specified in FIG. 7 by adding 10 interface tabs, requesting access to icon groups added in its icon management interface, and adding icon with IID of 111111111 into the interface tab, also accessing ABC company IoT monitoring interface “production floor monitoring panel” into another interface tab, we assume that the all access authorization and authentication have been approved,

The request contained the icon object with the icon number IID=1000001 is sent to the IIMS server via HTTP/HTTPS by REST request or SOAP request, and the IIMS server receives the icon object containing information of the POA data structure specified in FIG. 5;

The IIMS server invokes the corresponding processes to parse the received icon object with IID=1000001, and separate coming data into several different service requirements; then IIMS server will call different programs and services to handle different requirements according to different service requirements parsed;

The IIMS server resolves the first requirement directly according to the established rules. Currently, the user is allowed to establish 10 interface tabs as requested, but at the same time the IIMS server prepare the bill to require the customer to pay $10 per interface tab per month for a total of $100; the actions to create all 10 interface tabs for the customer will take effect 24 hours after the payment received; This processing result is stored in the cache to wait for the processing result of another request, then to pack all results into one response package and send the response package back to the customer;

IIMS server then processes the second request with related program after parsing, first calls the database to collect all the relevant information of ABC company, and to verify whether the user TESTER is authenticated and authorized to log in and access the ABC company's resources of IoT. After verification, the customer TESTER is eligible to login and access all those authorized projects of IoT, but limitation is read only, ie, the user can only view or see, the user can operate the alarm and send notification but cannot directly interfere with the production process such as stop and restart the machines, the current authorization is only to see and monitor the operations with some limited actions of adjustment, but cannot interfere with process of production;

The IIMS server packages all the collected information such as requested icon number IID=1000001 with user's request with some stored information in database to send to the ABC company's IoT platform to inform them that the user TESTER wants to access their IoT website and their IoT resources with approved privilege; waiting for the ABC Internet of Things (IoT) company to reply;

The IIMS server receives a reply from the ABC Internet of Things (IoT) company, it approves the user TESTER's request, and also allows him to access what he requested, but not more than 30 minutes;

The IIMS server packs all the replied detailed results from the ABC Internet of Things (IoT) company plus the previous processed result of request to create 10 interface tabs into one icon object, encrypts it and then send it back to the user TESTER as a large response package, and stores all the requests of the user TESTER and the processing results as response into the local database with the icon number IID=1000001.

The user TESTER receives the encrypted and packaged processing response from the IIMS server, the local program starts decrypting, parsing, and triggering the dialog box to pop up to require the user TESTER to pay a monthly bill of $100 US dollars to create his requested 10 interface tabs as his resource spaces for his icon IID=100001;

The user TESTER pays the bill with a credit card, and the transaction is completed within 24 hours, once done, 10 interface tabs will be created but need TESTER to rename each of them;

The user TESTER sees the second dialog box popping up to instruct him to open the web page of the company's ABC's Internet of Things (IoT), and tell him that he only has 30 minutes of access time of this IoT resources, after that, it will be timeout and the connection will be closed;

After entering the password, the user TESTER enters the IoT page of the company's ABC through IP address linked and he observes the running status of the machine 1, 2, 3, . . . , 20, everything is fine. A row of buttons next to the control panel indicates that he can adjust each running state of the machine, for example, adding oil, switching tool cutters, temperature adjustment, grinding speed adjustment, etc.;

In the 15th minute, the user TESTER observed that the machine 5 running status indicator is red, the temperature reached 900 degrees; the tool head was overheated, it needs to add coolant, the user TESTER presses the add coolant button, within 5 minutes, the temperature drops to 300 degrees, the indicator light turns green again;

The user TESTER observed that it took almost 15 minutes to complete the processing; then he send the alarm and notification of the abnormal status processing on IoT site to the manager and c/c to himself, then task automatically ended and the ABC IoT connection was disconnected;

The user TESTER receives the notification from the IIMS server that IIMS receives his payment and he is permitted to create 10 interface tabs as requested.

The user TESTER starts to create 10 interface tabs and add some social and relative group icons into these interface tabs respectively, then sends his daily greeting to all icon members in the icon social/relatives groups he just added to complete his tasks.

### Specific Embodiment 2

We can replace the above user TESTER with any GIS user, Internet user, IoT user, or even any LAN user. The hosts can be the Internet, Internet of Things (IoT), GIS and any local area network. The IoT production workshop can be replaced by any harbor port, any airport, any railway station and any military bases etc., the results are same.

The above descriptions are merely examples of the present invention, and are not intended to limit the scope of the present invention. Any equivalent structure or equivalent process transformation made by using the contents, concepts, standards and drawings of FIG. 3, FIG. 5 and FIG. 7 or architecture or data structures specified in FIG. 3, FIG. 5 and FIG. 7 of the present specification is directly or indirectly applied in other related technical fields, the same applies to the protection scope of the present invention. Furthermore, the appended claims of the present invention are intended to cover all changes and modifications that fall within the scope and the borderline of the present invention, or the equivalents of such scopes and boundaries. All such equivalent embodiments and examples are within the spirit and scope of the present invention, are contemplated thereby, and are intended to be covered by the these claims.

### REFERENCES

[1]. https://www.ics.uci.edu/˜fielding/pubs/dissertation/fielding_dissertation.pdf
[2]. https://segmentfault.com/a/1190000008938983
[3]. https://en.wikipedia.org/wiki/IPv6
[4]. USPTO application Ser. No. 16/040,917, title of «The Foundation Theory and Method of Internet Map/Platform Iconology/Markerology»
[5]. https://en.wikipedia.org/wiki/Resource-oriented_architecture

What is claimed is:

1. Initiate and implement a completely new Theory and Method of Unified Internet Integration (UII), characterized in followings:
The Theory and Method of Unified Internet Integration (UII) in the present invention includes a complete theoretical icon system, a set of concept definitions and a series of rules stipulated. According to the present invention, the user can integrate the Internet, GIS, IoT, Block-chain and all local area networks into a whole by using of the icon positioning object, icon information management system (IIMS) server and the Positioning-Oriented Architecture (POA) design invented in the present invention, It is impossible with all traditional Internet theory and technologies.

2. For the claim 1, the Theory and Method of Unified Internet Integration (UII), which includes:
The Foundation theory and Method of Iconology, Positioning-Oriented Architecture (POA) design, Icon Positioning Object, the data structure of POA for icon positioning resources, icon information management system (IIMS) server, icon information Bus (IIB) as shown in FIG. 3, FIG. 5 and FIG. 7.

3. For the claim 1, the Theory and Method of Unified Internet Integration (UII), which includes: The present invention is based on the Cantor's infinity theory to abstract all different types resources into different types of sets, to define the concepts of quantifying the scopes and boundaries of sets of these different types of resources in the Internet and information science, especially the concept of quantifying the maximum upper limit of cardinality (MULC) of various sets of resource in the Internet, and to define the concept of using the maximum upper limit of cardinality (MULC) of various sets of resources to determine the logic position of the sets of different resources in the relations between these various subsets of resources and the set of icon positioning resources.

4. For the claim 1, the Theory and Method of Unified Internet Integration (UII), which includes:
For the first time in the world, the relation between the maximum upper limit of cardinality (MULC) of sets of different types of resources between POA, ROA and SOA is explicitly stated in the present invention;
The maximum upper limit of cardinality (MULC) of positioning resources of POA is the first-level infinite multiple of that of ROA and that of SOA; the maximum upper limit of cardinality (MULC) the resource of ROA is the finite multiple of that of SOA;
the controllable positioning resources and IP address resources and service resources are the three most important basic backbone resources of the Internet; IP address resources and service resources are the basic backbone resources of the traditional Internet; Controllable positioning resources are the most critical and fundamental resources of the Internet in the future, and are the largest resources of the Internet developed by our series of inventions.

5. For the claim 1, the Theory and Method of Unified Internet Integration (UII), which includes:
In the present invention, all of the following descriptions are equivalent, that is, the naming convention is consistent, and all are architectural designs for icon positioning resources oriented: Positioning Oriented Architecture (POA) is the same as Icon Oriented Architecture (IOA) and is also the same as Marker Oriented Architecture (MOA), all referred to as POA, IOA or MOA.

6. For the claim 1, the Theory and Method of Unified Internet Integration (UII), which includes:
The Positioning-Oriented Architecture (POA) design of icon positioning resources consists of at least the following eight components:
(1) Positioning resources (icons);
(2) Positioning resource Identification (unique icon identification number IID);
(3) Description of the positioning resource (icon description, including GPS/or Beidou positioning values such as Longitude, Latitude, Altitude, etc.);
(4) Resource space for each positioning resources and their operation management (icon resource space);
(5) The relation between different positioning resources (the relation between a current icon and multiple focused icons, links, communication methods, operations, group attribution, etc.);
(6) Local IP address resources (multiple) such as IoT/GIS/Block Chain associated with each positioning resource or icon;
(7) The service types associated with each IP address resource (multiple) in the local area network such as IoT, these IP address resource are also associated with each positioning resources (optional) or icons;
(8) The methods associated with the each service (multiple|optional);
See FIG. 5 and FIG. 7.

7. For the claim 1, the Theory and Method of Unified Internet Integration (UII), which includes:
The data structure of the POA is described in detail below.
(1) Icon positioning resource identification number IID;
(2) Icon positioning resource (GPS/Beidou positioning);
(3) Icon positioning resource space management (manage resource spaces of each icon);
(4) Icon positioning resource management (manage groups of icons);
(5) Icon positioning external resource link management;
(6) Icon positioning resource current status and its status management interfaces;
The data structure of the POA in the present invention determines the positions of the traditional resource-oriented architecture (ROA) and the service-oriented architecture (SOA) in the whole structure of POA, this newly invented data structure is for the next new generation of internet/network architecture design, it also shows the possible data schema currently used such as JASON, XML etc, as shown in FIG. 5.

8. For the claim 1, the Theory and Method of Unified Internet Integration (UII), which includes:
The present invention constructs a generic, universal and comprehensive framework, it is suitable for integration applications of the next generation of the Internet, all local area networks such as GIS, Internet of Things (IoT), blockchain, all other local area network, mobile phone terminals applications and PC throughout the world. The present invention based on the foundation theory and method of Internet Iconology we invented before has fully implemented the core theory and technologies of controlling and managing of positioning resources, The present invention is especially suitable for all fields such as The Internet, The Internet of Things (IoT), LAN, GIS and blockchain, which require the positioning of machines and objects. The present invention has broken the bottleneck of the huge market of 50 billion machine objects of IoT and that of the market of blockchain and GIS to be integrated into the Internet.

9. For the claim 1, the Theory and Method of Unified Internet Integration (UII), which includes:
The embodiments of the present invention are merely some examples of the present invention, and are not intended to limit the scope of the present invention. Any equivalent structure or equivalent process transformation made by using the contents, concepts, standards and drawings of FIG. 3, FIG. 5 and FIG. 7 or architecture or data structures specified in FIG. 3, FIG. 5 and FIG. 7 of the present specification is directly or indirectly applied in other related technical fields, the same applies to the protection scope of the present invention. Furthermore, the appended claims of the present invention are intended to cover all changes and modifications that fall within the scope and the borderline of the present invention, or the equivalents of such scopes and boundaries.
